(19) United States
(12) Patent Application Publication
(10) Pub. No.: US 2010/0283729 A1
(43) Pub. Date: Nov. 11, 2010

(54) CONTROL METHOD FOR CONTROLLING HANDHELD ELECTRONIC DEVICE

(75) Inventors: Antony Ying-Chih SUNG, SHANGHAI (CN); Lu WANG, SHANGHAI (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/773,026

(22) Filed: May 4, 2010

(30) Foreign Application Priority Data
May 5, 2009 (TW) 98114889

(51) Int. Cl. G09G 5/00; G06F 3/045

(52) U.S. Cl. 345/157; 345/174

(57) ABSTRACT

A control method for controlling a handheld electronic device comprising a screen and a touch pad is provided. The screen is used for displaying a frame. The control method comprises the following steps. The frame comprising at least one option and a controlled object is displayed. A radial input with respect to the touch pad is detected. A shifting direction of the controlled object according to the radial input is controlled so as to switch between the options. A rotational input with respect to the touch pad is detected. One of the options according to the rotational input is selected.

### RELATED APPLICATIONS

This application claims priority to Taiwan Application Serial Number 98114889, filed May 5, 2009, which is herein incorporated by reference.

### BACKGROUND

1. Technical Field

The present disclosure relates to an operation method of an electronic device. More particularly, the present disclosure relates to a control method for controlling a handheld electronic device.

2. Description of Related Art

Handheld electronic devices such as cell phone, PDA and MP3 player have become indispensable in everyday life. To control the handheld electronic devices, buttons are often used to input the command to control the options on the display unit of the electronic devices to make the electronic devices perform specific functions. However, the control method described above makes the user suffer from lots of constraints. In other devices, a touch panel is used to make the user directly select the options. However, the user may fail to operate the electronic devices correctly if the sensitivity of the display panel is too high or too low.

Accordingly, what is needed is a control method for controlling a handheld electronic device to integrate the button input method and the touch input method to overcome the above issues. The present disclosure addresses such a need.

### SUMMARY

A control method for controlling a handheld electronic device comprising a screen and a touch pad is provided. The screen is used for displaying a frame. The control method comprises the following steps. The frame comprising at least one option and a controlled object is displayed. A radial input with respect to the touch pad is detected. A shifting direction of the controlled object according to the radial input is controlled so as to switch between the options. A rotational input with respect to the touch pad is detected. One of the options according to the rotational input is selected.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a top view of a handheld electronic device of an embodiment of the present disclosure;

FIG. 2 is a cross-section view of the touch pad in FIG. 1;

FIG. 3 is a flow chart of a control method in an embodiment of the present disclosure for controlling a handheld electronic device; and

FIG. 4 is a flow chart of a control method in another embodiment of the present disclosure for controlling a handheld electronic device.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

Please refer to FIG. 1. FIG. 1 is a top view of a handheld electronic device 1 of an embodiment of the present disclosure. The handheld electronic device 1 comprises a host 10, a screen 12, a touch pad 14 and a plurality of controlled buttons 16.

The host 10 provides a plurality of application programs (not shown). The screen 12 is disposed on a surface 102 of the host 10. In the present embodiment, the screen 12 is, for example, a liquid crystal display to show a frame 120 related to one of the application programs. In other words, when the host 10 initiates a specific application program, the content of the application program is shown on the frame 120 to inform the user the operating status of the application program. The screen 120 has a plurality of options 120a and a controlled object (not shown).

The touch pad 14 is disposed on a surface of the host. In the present embodiment, the touch pad 14 is disposed on the same surface 102 as the screen 12. The touch pad 14 located next to the screen 12 can be a resistive or a capacitive touch pad. The controlled buttons 16 are disposed at an inner area 140 of the touch pad 14.

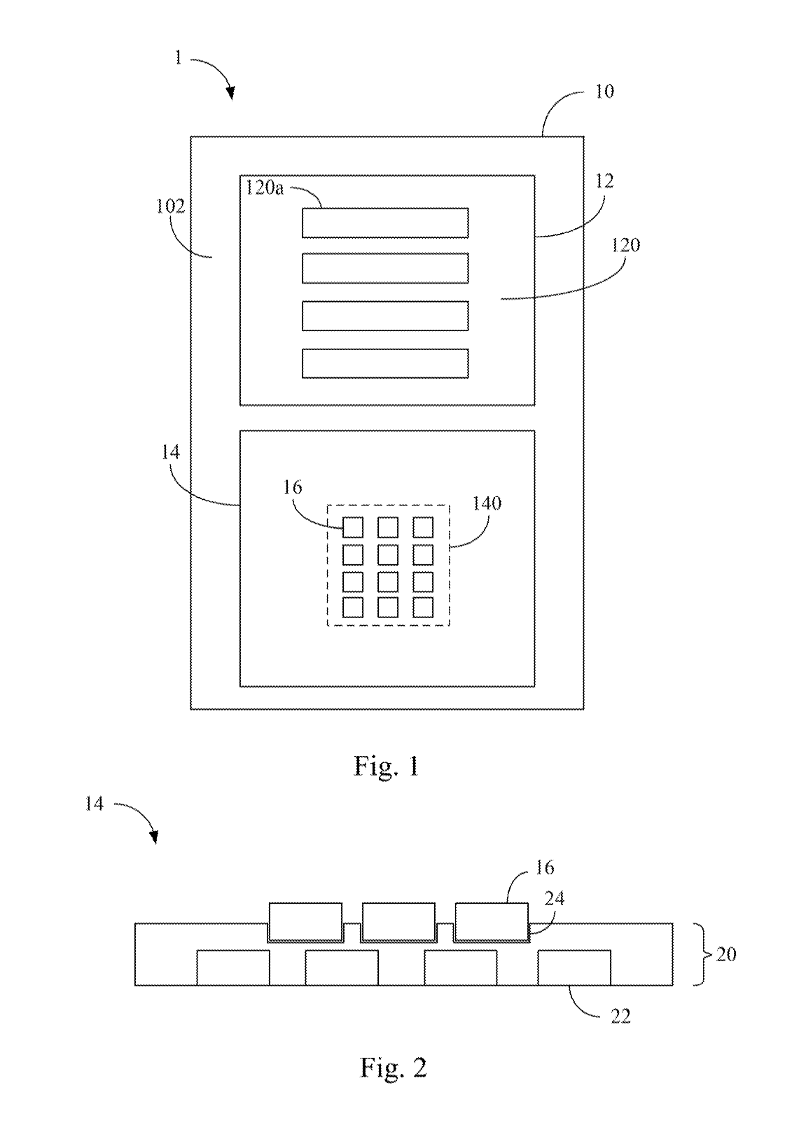

Please refer to FIG. 2 at the same time. FIG. 2 is a cross-section view of the touch pad 14. The touch pad 14 comprises an electrode layer 20 disposed at the inner area 140 of the touch pad 14. The electrode layer 20 comprises electrodes 22 and several recess parts 24. The controlled buttons 16 are substantially disposed at the recess parts 24 and being exposed on the touch pad 14.

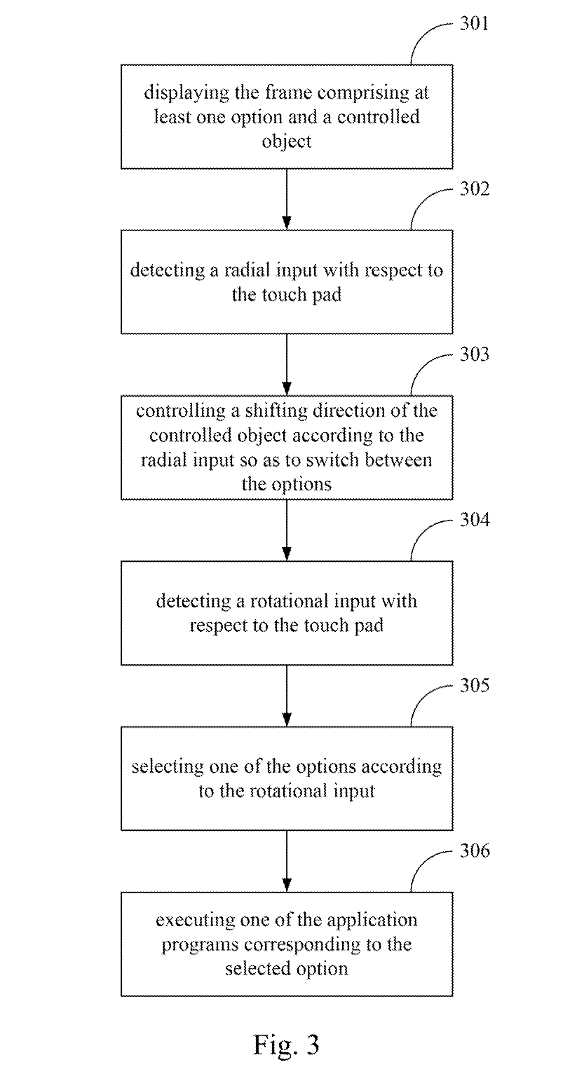

Please refer to FIG. 3. FIG. 3 is a flow chart of a control method in an embodiment of the present disclosure for controlling a handheld electronic device. The control method can be adapted to the handheld electronic device 1 depicted in FIG. 1. The control method comprises the following steps. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 301, the frame 120 comprising the options 120a and the controlled object is displayed on the screen 12. In step 302, a radial input with respect to the touch pad 14 is detected. In step 303, a shifting direction of the controlled object of the frame 120 is controlled so as to switch between the options 120a.

In an embodiment, the controlled object is a cursor. The user can perform the radial input with a finger or a pen on the touch pad 14 to control the shifting direction of the cursor on the frame 120 according to the radial input, so as to move the cursor to one of the options 120a. In another embodiment, the controlled object is a selecting frame. The user can perform the radial input with a finger or a stylus on the touch pad 14 to control the shifting direction of the selecting frame according to the radial input, so as to switch between different options 120a. In yet another embodiment, the controlled object is an adjusting bar to adjust the control interface of the handheld electronic device 1 such as a volume control bar or a brightness control bar. Each value on the adjusting bar is an option that can be selected by the radial input. In other words, the user can perform the radial input with a finger or a stylus on the touch pad 14 to control the shifting direction of the adjusting bar according to the radial input, so as to switch between different options (i.e. different values).

After the step 303, the rotational input with respect to the touch pad 14 is detected in step 304. Then, one of the options 120a is selected according to the rotational input in step 305. In step 306, the application program corresponding to the selected option is executed.

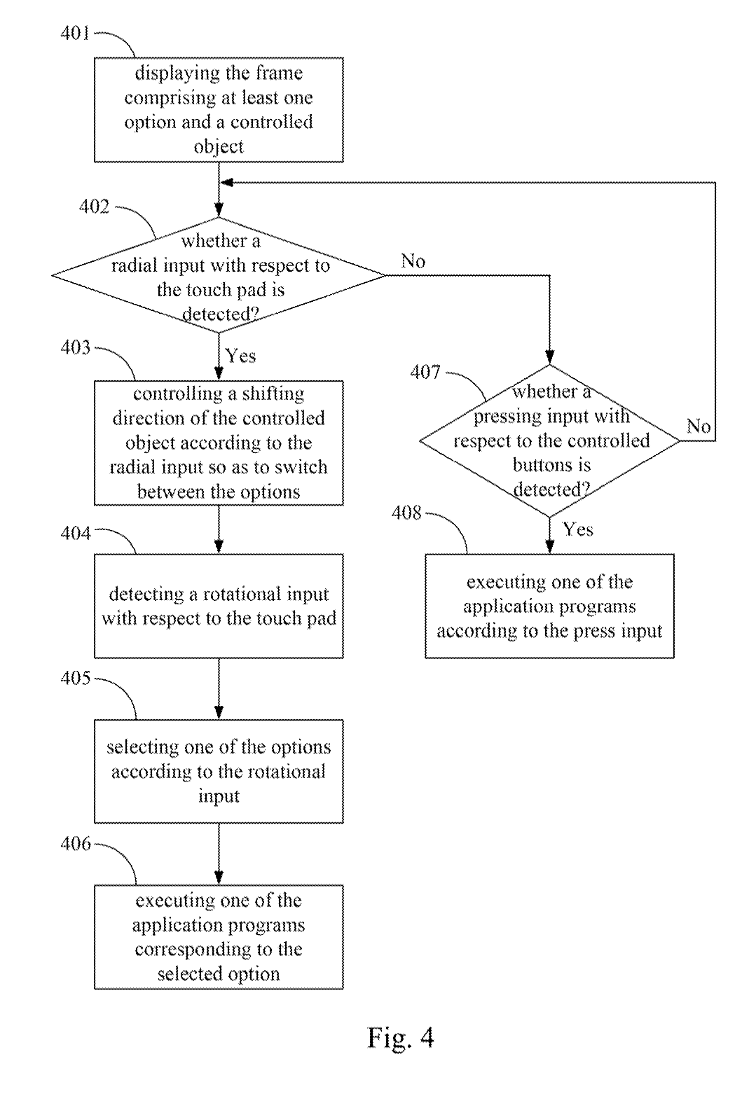

In another embodiment, the options can be selected with the controlled buttons 16. Please refer to FIG. 4. FIG. 4 is a flow chart of a control method in another embodiment of the present disclosure for controlling a handheld electronic device. The control method can be adapted to the handheld electronic device 1 depicted in FIG. 1. The control method comprises the following steps. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 401, the frame 120 comprising the options 120a and a controlled object is displayed on the screen 12. In step 402, whether a radial input with respect to the touch pad 14 is detected is determined. When the radial input is detected, the shifting direction of the controlled object of the frame 120 is controlled so as to switch between the options 120a.

After the step 403, the rotational input with respect to the touch pad 14 is detected in step 404. Then, one of the options 120a is selected according to the rotational input in step 405. In step 406, one of the application programs corresponding to the selected option is executed.

When the radial input is not detected, whether a pressing input with respect to the controlled buttons 16 is detected in step 407. When the device detects that one of the controlled buttons 16 is pressed, the corresponding application program is executed according to the press input in step 408. The controlled buttons 16 can be function keys, number keys or a combination of both function keys and number keys, depending on different situations. When the pressing input is not detected, step 402 is performed again to detect whether the radial input with respect to the touch pad 14 is generated.

The present disclosure provides a control method for controlling the handheld electronic device with both the radial and rotational inputs of the touch pad and the controlled buttons. The integration of the touch pad and the controlled buttons makes the user control the device without constraints.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A control method for controlling a handheld electronic device comprising a screen and a touch pad, wherein the screen is used for displaying a frame, and the control method comprises:
displaying the frame comprising at least one option and a controlled object;
detecting a radial input with respect to the touch pad;
controlling a shifting direction of the controlled object according to the radial input, so as to switch between the options;
detecting a rotational input with respect to the touch pad; and
selecting one of the options according to the rotational input.

2. The control method of claim 1, wherein the handheld electronic device further comprises a host for providing a plurality of application programs, the screen and the touch pad are disposed on a surface of the host.

3. The control method of claim 2 further comprising:
executing one of the application programs corresponding to the selected option.

4. The control method of claim 2, wherein the touch pad comprises an electrode layer disposed at an inner area of the touch pad and having several recess parts, the handheld electronic device further comprises a plurality of controlled buttons disposed at the recess parts and being exposed on the touch pad, and the control method further comprises:
detecting a pressing input with respect to the controlled buttons; and
executing one of the application programs according to the press input.

5. The control method of claim 1, wherein the controlled object is a cursor, a selecting frame or an adjusting bar.

6. The control method of claim 1, wherein the touch pad is a resistive touch pad.

7. The control method of claim 1, wherein the touch pad is a capacitive touch pad.

8. The control method of claim 4, wherein the controlled buttons comprise a function key.

9. The control method of claim 4, wherein the controlled buttons comprise a number key.
